(19) United States
(12) Patent Application Publication
(10) Pub. No.: US 2026/0131236 A1
(43) Pub. Date: May 14, 2026

(54) CONTROL HANDLE AND CONNECTOR ASSEMBLY

(71) Applicant: DEXIN CORPORATION, New Taipei City (TW)

(72) Inventors: HO-LUNG LU, NEW TAIPEI CITY (TW); Yi-Chen Liu, New Taipei City (TW)

(21) Appl. No.: 19/179,081

(22) Filed: Apr. 15, 2025

Related U.S. Application Data
(60) Provisional application No. 63/720,308, filed on Nov. 14, 2024.

(30) Foreign Application Priority Data
Feb. 11, 2025 (TW) 114104926

(51) Int. Cl. A63F 13/24

(52) U.S. Cl. CPC A63F 13/24

(57) ABSTRACT

A control handle and a connector assembly. The control handle includes two handle portions, a support portion, and a connector assembly. Multiple operation components are disposed on each of the two handle portions. Each of the operation components is configured to be operable by a user for correspondingly generating a control signal. Two ends of the support portion are connected to the two handle portions, and the control handle is configured to hold an electronic device. The connector assembly includes at least two connectors of different types. Each of the at least two connectors is movably disposed in one of the handle portions, and is operable to protrude from an inner side of the handle portion. The connector that protrudes from the inner side of the handle portion is configured to be mated with a mating connector of the electronic device that is held by the control handle.

### CROSS-REFERENCE TO RELATED PATENT APPLICATION

This application claims the benefit of priorities to the U.S. Provisional Patent Application Ser. No. 63/720,308, filed on Nov. 14, 2024, and Taiwan Patent Application No. 114104926, filed on Feb. 11, 2025. The entire content of each of the above identified applications is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a control handle and a connector assembly, and more particularly to a control handle for holding an electronic device and a connector assembly for being installed in said control handle.

### BACKGROUND OF THE DISCLOSURE

A conventional control handle that is commonly used to hold an electronic device (e.g., a smartphone or a tablet computer) can only be used to connect with the electronic device having a connector of a specific specification, and is unable to connect with the electronic device of a different type of specification.

### SUMMARY OF THE DISCLOSURE

In response to the above-referenced technical inadequacy, the present disclosure provides a control handle and a connector assembly, so as to improve the problem of a conventional control handle being only able to connect with an electronic device having a connector of a specific specification and being unable to connect with an electronic device of a different type of specification.

In order to solve the above-mentioned problem, one of the technical aspects adopted by the present disclosure is to provide a connector assembly of a control handle. The connector assembly is movably disposed in the control handle, the control handle includes two handle portions and a support portion, a plurality of operation components are disposed on each of the two handle portions, and each of the plurality of operation components is configured to be operable by a user for correspondingly generating a control signal. Two ends of the support portion are connected to the two handle portions, and the control handle is configured to hold an electronic device. The connector assembly includes at least two connectors of different types. Each of the at least two connectors is movably disposed in one of the handle portions, each of the at least two connectors is operable to protrude from an inner side of the handle portion, and the connector that protrudes from the inner side of the handle portion is configured to be mated with a mating connector of the electronic device that is held by the control handle.

In order to solve the above-mentioned problem, another one of the technical aspects adopted by the present disclosure is to provide a control handle, which includes two handle portions, a support portion, and a connector assembly. A plurality of operation components are disposed on each of the two handle portions, and each of the plurality of operation components is configured to be operable by a user for correspondingly generating a control signal. Two ends of the support portion are connected to the two handle portions, and the control handle is configured to hold an electronic device. The connector assembly includes at least two connectors of different types. Each of the at least two connectors is movably disposed in one of the handle portions, each of the at least two connectors is operable to protrude from an inner side of the handle portion, and the connector that protrudes from the inner side of the handle portion is configured to be mated with a mating connector of the electronic device that is held by the control handle.

In order to solve the above-mentioned problem, yet another one of the technical aspects adopted by the present disclosure is to provide a control handle, which includes two handle portions, a support portion, and a connector assembly. A plurality of operation components are disposed on each of the two handle portions, and each of the plurality of operation components is configured to be operable by a user for correspondingly generating a control signal. Two ends of the support portion are connected to the two handle portions, and the control handle is configured to hold an electronic device. The connector assembly includes at least two connectors of different types. The at least two connectors are movably disposed in the two handle portions, each of the at least two connectors is operable to protrude from an inner side of a corresponding one of the handle portions, and the connector that protrudes from the inner side of the handle portion is configured to be mated with a mating connector of the electronic device that is held by the control handle.

Therefore, in the control handle and the connector assembly provided by the present disclosure, by virtue of the at least two connectors of different types, the user can correspondingly control one of the connectors in the control handle to protrude from the inner side of the handle portion according to a type of the connector in the electronic device. Accordingly, the control handle of the present disclosure can solve the problem of a conventional control handle being only able to connect with an electronic device having a connector of a specific specification.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 and FIG. 2 are schematic views of a control handle according to a first embodiment of the present disclosure from different angles of view;

FIG. 3 is a schematic partially exploded view of the control handle according to the first embodiment of the present disclosure;

FIG. 4 to FIG. 6 are each a schematic view illustrating actuation of a connector assembly of the control handle according to the first embodiment of the present disclosure;

FIG. 7 is a schematic exploded view of the connector assembly of the control handle according to the first embodiment of the present disclosure;

FIG. 8 is a partial cross-sectional view of the control handle according to the first embodiment of the present disclosure;

FIG. 9 is another partial cross-sectional view of the control handle according to the first embodiment of the present disclosure;

FIG. 10 is a schematic exploded view of the connector assembly of the control handle according to the first embodiment of the present disclosure;

FIG. 11 is a schematic view of a control handle according to a second embodiment of the present disclosure;

FIG. 12 is a schematic partial view of the control handle according to the second embodiment of the present disclosure;

FIG. 13 is a schematic partially exploded view of the control handle according to the second embodiment of the present disclosure;

FIG. 14 is a partial top view of the control handle according to the second embodiment of the present disclosure;

FIG. 15 is a top view illustrating actuation of a control handle according to a third embodiment of the present disclosure; and

FIG. 16 is a top view illustrating actuation of a control handle according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

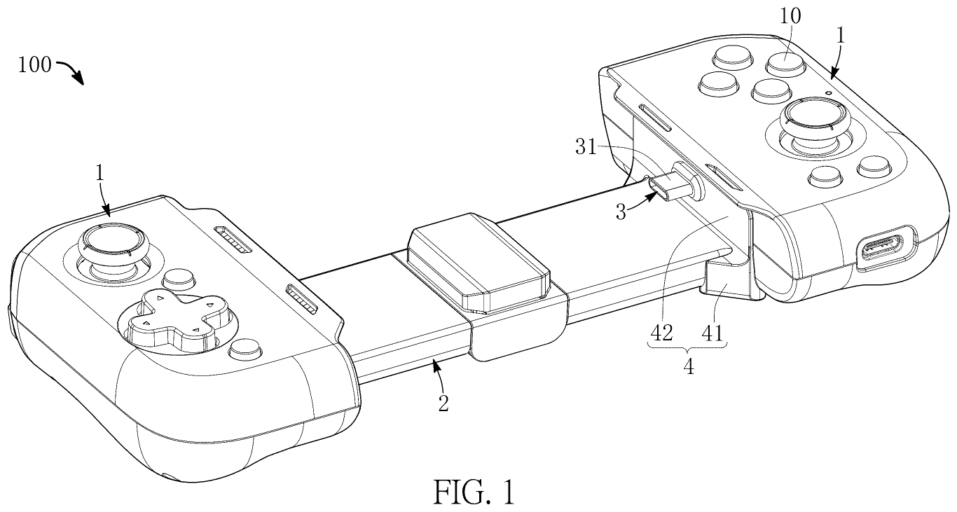

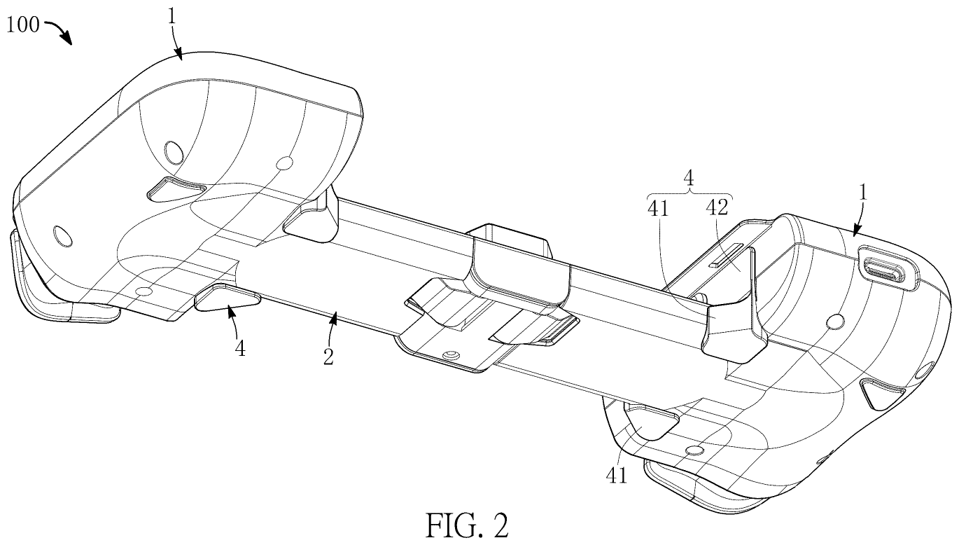

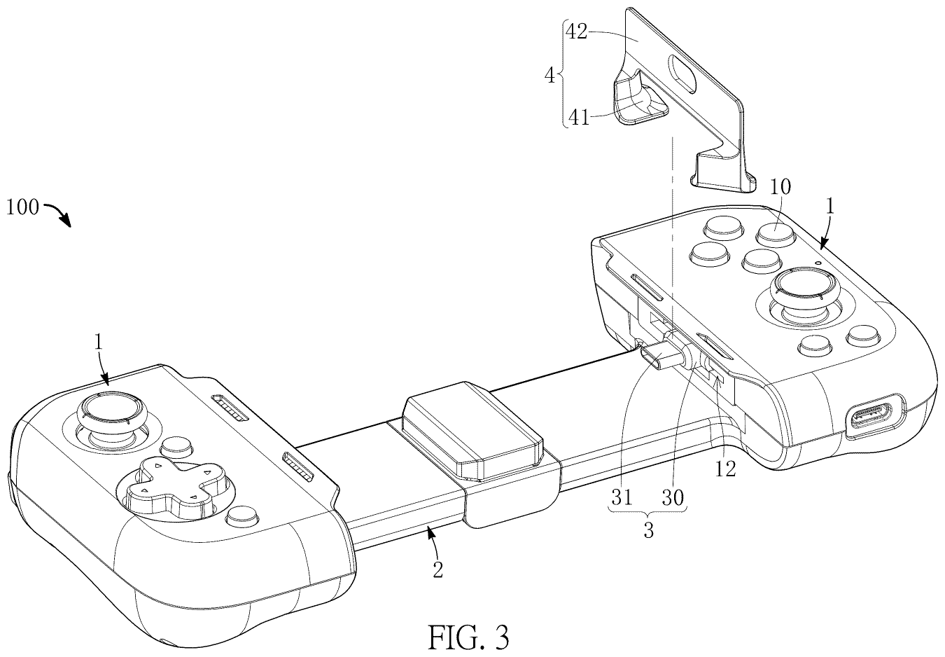

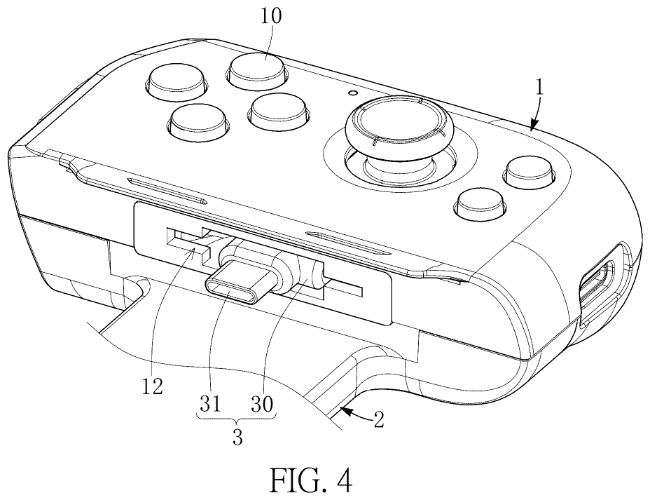

Referring to FIG. 1 to FIG. 6, FIG. 1 and FIG. 2 are schematic views of a control handle according to a first embodiment of the present disclosure from different angles of view, FIG. 3 is a schematic partially exploded view of the control handle according to the first embodiment of the present disclosure, and FIG. 4 to FIG. 6 are each a schematic view illustrating actuation of a connector assembly of the control handle according to the first embodiment of the present disclosure.

A control handle 100 of the present disclosure includes two handle portions 1, a support portion 2, and a connector assembly 3. A plurality of operation components 10 are disposed on each of the two handle portions 1, and each of the operation components 10 is configured to be operable by a user for correspondingly generating a control signal. The operation component 10 can be, for example, a button, a touch panel, or a joystick. Two ends of the support portion 2 are connected to the two handle portions 1, and the control handle 100 is configured to hold an electronic device. The electronic device can be, for example, a tablet or a smartphone.

After the electronic device is installed with the control handle 100, the user can transmit the control signal to the electronic device by operating the operation components 10, so as to interact with application programs in the electronic device. For example, the application program can be a game, and the control handle 100 can act as a gamepad after the electronic device is installed with the control handle 100. In one variation, the two handle portions 1 or the support portion 2 can have a movable mechanism, and the user can operate the movable mechanism for moving the two handle portions 1 away from one another. In this way, the control handle 100 can hold an electronic device having a larger size.

The connector assembly 3 includes at least two connectors of different types (e.g., a Type-C connector, Lightning, and a micro universal serial bus (USB) connector). In the present embodiment, the connector assembly 3 is exemplified as including two connectors of different types. However, a quantity of the connectors in the connector assembly 3 can be three or more than three, and is not limited thereto.

In the present embodiment, the two connectors are respectively defined as a first connector 31 and a second connector 32, and are disposed in a main body 30 of the connector assembly 3. In addition, the first connector 31 and the second connector 32 are electrically connected to a circuit module 11 that is disposed in the handle portion 1 via, for example, an electrical wire 33. The electrical wire 33 can be connected to the circuit module 11 via, for example, a pluggable connector. The circuit module 11 is, for example, a motherboard that includes the control handle 100.

In the present embodiment, the first connector 31 and the second connector 32 are exemplified as being connected to the circuit module 11 via one electrical wire 33. However, the present disclosure is not limited thereto. In other embodiments, the first connector 31 and the second connector 32 can also be connected to the circuit module 11 via two electrical wires 33.

In the present embodiment, the main body 30 is exemplified as simultaneously covering a portion of the first connector 31 and a portion of the second connector 32, but is not limited thereto. In other embodiments, each of the first connector 31 and the second connector 32 can also be an independent component, and the first connector 31 is fixed to the second connector 32 via other components.

In practice, the pluggable connector is disposed at one end of the electrical wire 33 in the connector assembly 3, and a circuit board of the circuit module 11 includes a corresponding mating connector, so that the connector assembly 3 can be independently sold, manufactured, or implemented. In other words, the connector assembly 3 of the control handle 100 can be easily replaced.

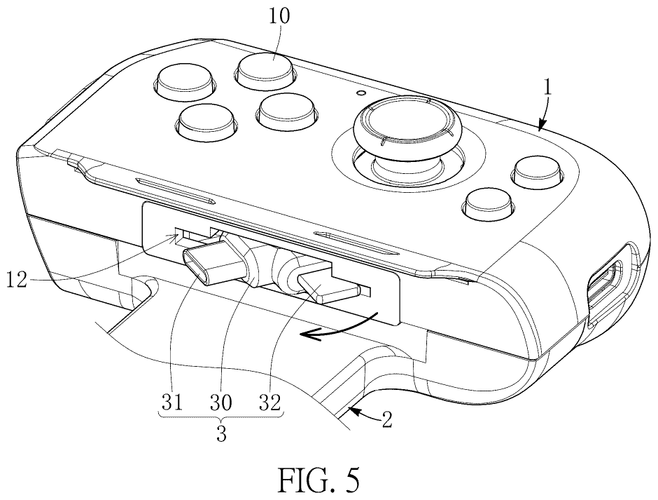

As shown in FIG. 4 and FIG. 5, an inner side of the handle portion 1 on which the first connector 31 and the second connector 32 are disposed has an opening 12. The main body 30 is rotatably disposed in the handle portion 1, and the connector assembly 3 is operable to rotate relative to the handle portion 1, so as to enable one of the connectors to protrude from the inner side of the handle portion 1.

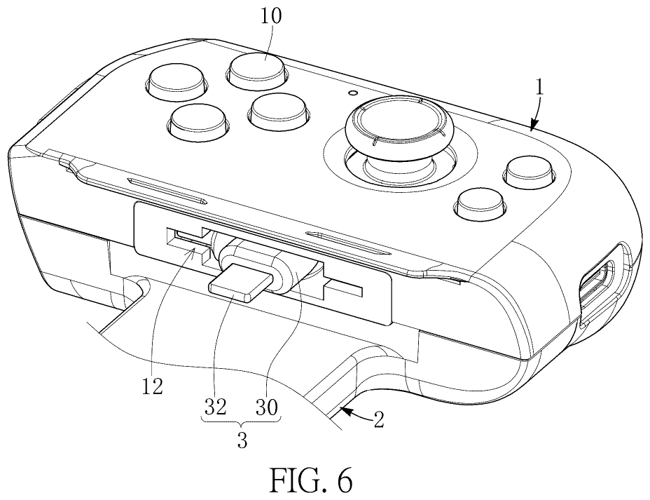

As shown in FIG. 4 and FIG. 6, when the user uses the control handle 100, the connector assembly 3 is able to rotate relative to the handle portion 1 by actuating the first connector 31 or the second connector 32. After rotation, the first connector 31 that originally protrudes from the handle portion 1 is hidden in the handle portion 1 through the opening 12, and the second connector 32 that is originally hidden in the handle portion 1 protrudes from the inner side of the handle portion 1 through the opening 12.

In the control handle 100 of the present disclosure, the connector assembly 3 is designed to be disposed in the handle portion 1 and include the two connectors of different types. In this way, according to practical requirements, the user can easily operate the connector assembly 3 for manipulating the required connector to protrude from the inner side of the handle portion 1.

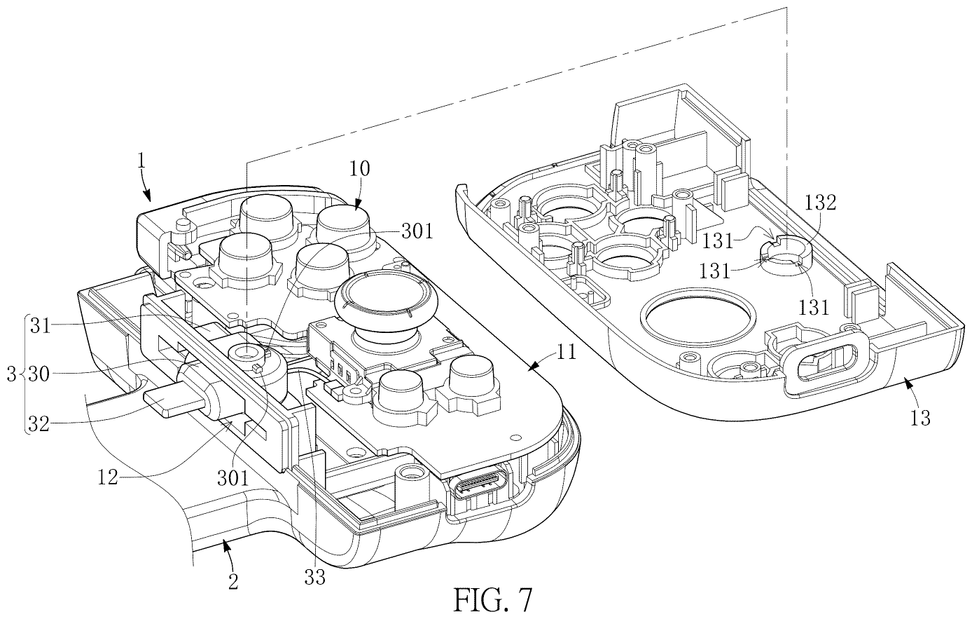

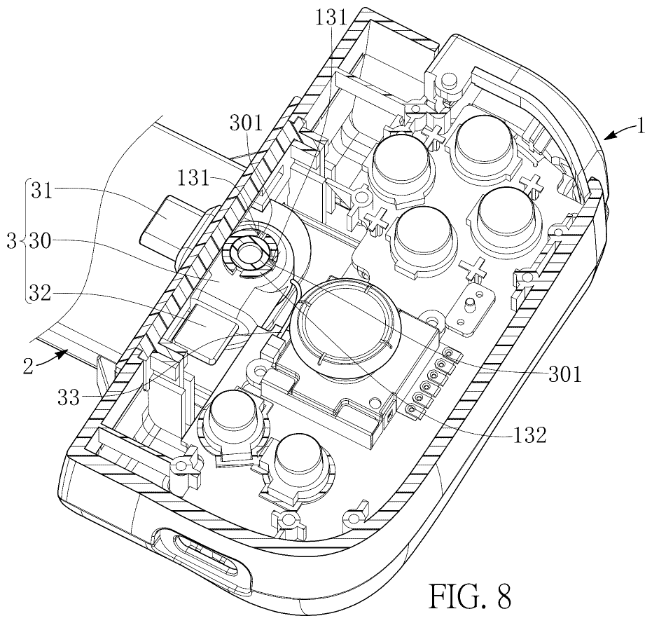

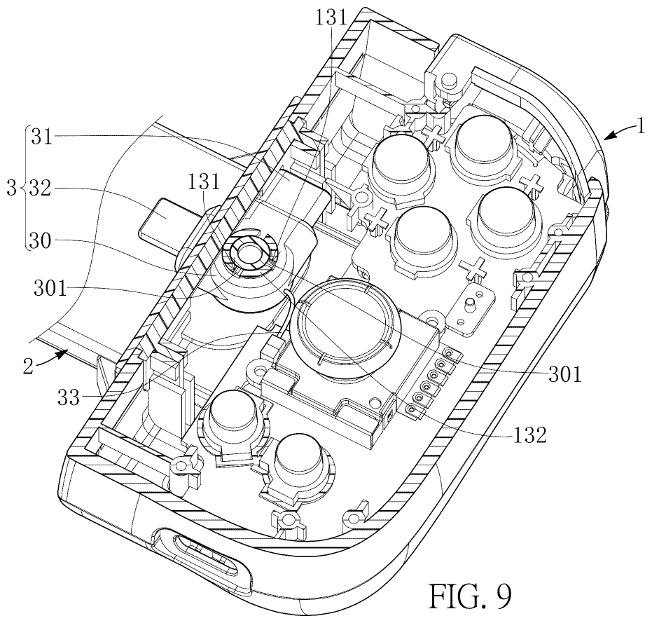

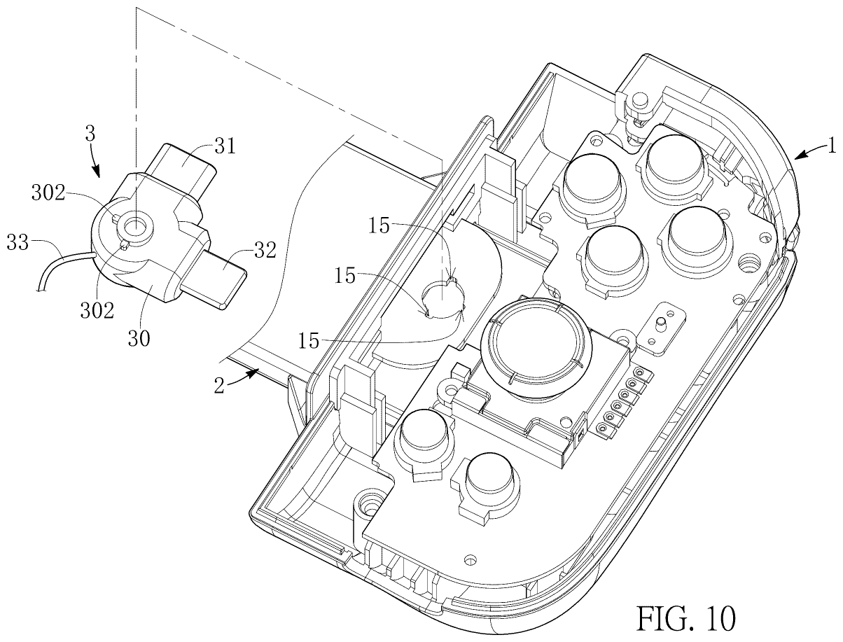

Referring to FIG. 7 to FIG. 10, FIG. 7 is a schematic exploded view of the connector assembly of the control handle according to the first embodiment of the present disclosure, FIG. 8 is a partial cross-sectional view of the control handle according to the first embodiment of the present disclosure, FIG. 9 is another partial cross-sectional view of the control handle according to the first embodiment of the present disclosure, and FIG. 10 is a schematic exploded view of the connector assembly of the control handle according to the first embodiment of the present disclosure.

In practice, the main body 30 of the connector assembly 3 can be configured to include two main body positioning structures 301, and three handle positioning structures 131 are correspondingly disposed in the handle portion 1. The three handle positioning structures 131 are, for example, disposed on an inner side of an upper housing 13 of the handle portion 1. For example, each of the main body positioning structures 301 is a protruding structure, and each of the handle positioning structures 131 is a groove.

As shown in FIG. 8, when the first connector 31 protrudes from the inner side of the handle portion 1, the two main body positioning structures 301 are correspondingly engaged with two of the handle positioning structures 131, so as to limit a movement range of the connector assembly 3 relative to the handle portion 1. Conversely, as shown in FIG. 9, when the second connector 32 protrudes from the inner side of the handle portion 1, the two main body positioning structures 301 are also correspondingly engaged with two of the handle positioning structures 131, so as to limit the movement range of the connector assembly 3 relative to the handle portion 1.

Through the configuration of the main body positioning structures 301 and the handle positioning structures 131, the connector assembly 3 will not easily rotate relative to the handle portion 1 when the first connector 31 or the second connector 32 protrudes from the inner side of the handle portion 1. When the two main body positioning structures 301 and two of the handle positioning structures 131 are engaged with each other, the user can apply a greater force to the connector assembly 3, so that each of the main body positioning structures 301 is disengaged from a corresponding one of the handle positioning structures 131. In this way, the connector assembly 3 can rotate relative to the handle portion 1 until the two main body positioning structures 301 are once again engaged with two of the handle positioning structures 131.

As shown in FIG. 7, a baffle 132 is further disposed on the inner side of the upper housing 13 of the handle portion 1, and is configured to abut against the neighboring main body positioning structure 301, so that the connector assembly 3 is unable to rotate relative to the handle portion 1. In other words, referring to FIG. 4 to FIG. 6, when the user operates the connector assembly 3 in FIG. 4 to rotate clockwise, the connector that protrudes from the handle portion 1 will be changed from the first connector 31 as shown in FIG. 4 to the second connector 32 as shown in FIG. 6. Conversely, referring to FIG. 4 and FIG. 7, when the user operates the connector assembly 3 in FIG. 4 to rotate counterclockwise, one of the main body positioning structures 301 will abut against the baffle 132, and the connector assembly 3 will not be able to rotate. Hence, by designing the baffle 132 to be disposed on the inner side of the upper housing 13 of the handle portion 1, the user is prevented from rotating the connector assembly 3 in a wrong direction.

Reference is made to FIG. 7 and FIG. 10. In practice, the two main body positioning structures 301 are disposed on one side of the main body 30 of the connector assembly 3, and two auxiliary main body positioning structures 302 can be disposed on another side of the main body 30. Three auxiliary handle positioning structures 15 can also be disposed in an interior of the handle portion 1. Each of the auxiliary main body positioning structures 302 can be a protruding structure, and each of the auxiliary handle positioning structures 15 can be a groove. Actuations of the auxiliary main body positioning structures 302 and the auxiliary handle positioning structures 15 are the same as those of the main body positioning structures 301 and the handle positioning structures 131 mentioned above, and will not be reiterated herein. Through the configuration of the auxiliary main body positioning structures 302 and the auxiliary handle positioning structures 15, the connector assembly 3 can rotate relative to the handle portion 1 in a more stable manner.

Reference is made to FIG. 1 to FIG. 3. In one embodiment, the control handle 100 can, for example, further include a protection structure 4. The protection structure 4 includes a holding portion 41 and a shielding portion 42. The holding portion 41 is configured to clamp the support portion 2. The shielding portion 42 is configured to shield at least a portion of the opening 12 of the handle portion 1 in which the two connectors are disposed, so as to prevent the two connectors from being operated to move relative to the handle portion 1. In practice, the protection structure 4 can be, for example, a structure having a shape similar to an inverted letter “U”. Through the configuration of the protection structure 4, after the user operates the connector assembly 3 for manipulating the required connector to protrude from the inner side of the handle portion 1, the user can install the protection structure 4 on the handle portion 1, and rotation of the connection assembly 3 can be prevented in a more effective manner.

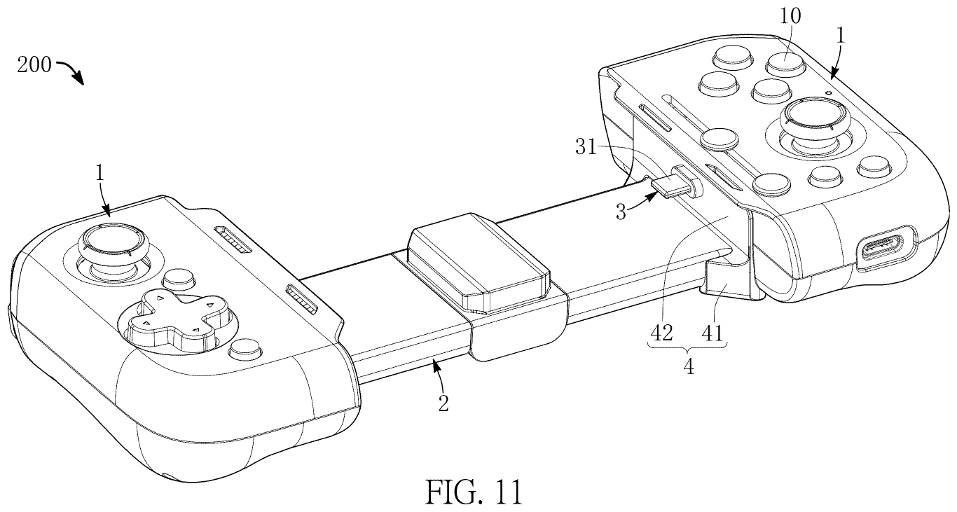

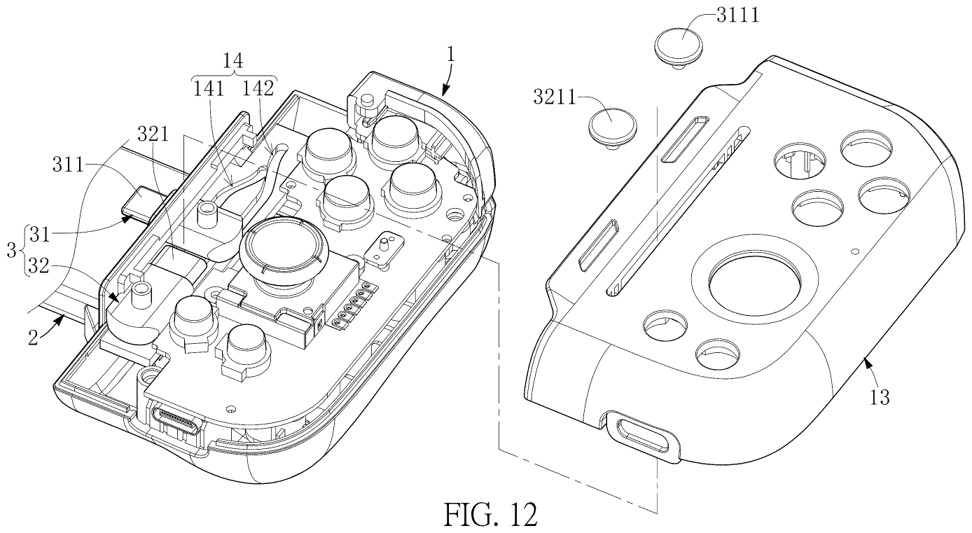

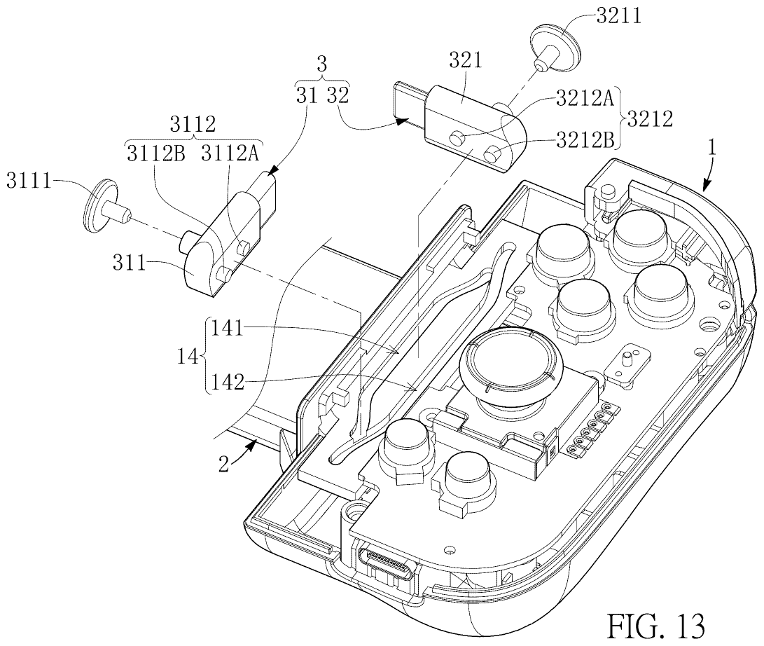

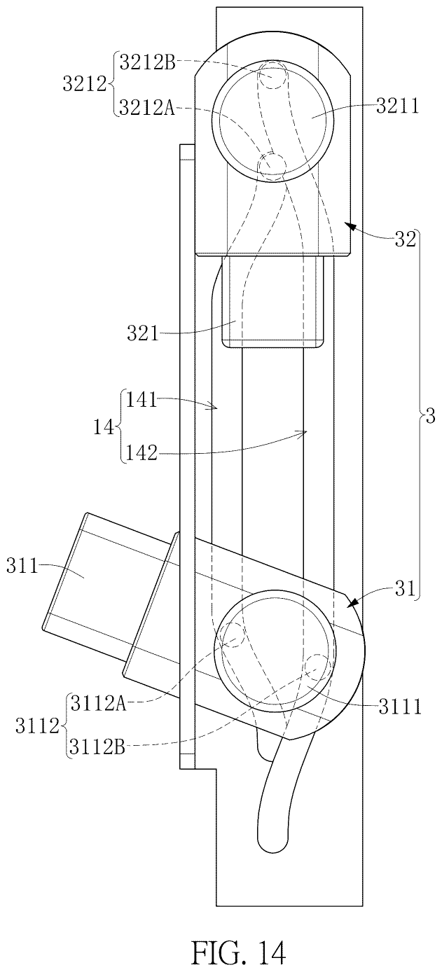

Referring to FIG. 11 to FIG. 14, FIG. 11 is a schematic view of a control handle according to a second embodiment of the present disclosure, FIG. 12 is a schematic partial view of the control handle according to the second embodiment of the present disclosure, FIG. 13 is a schematic partially exploded view of the control handle according to the second embodiment of the present disclosure, and FIG. 14 is a partial top view of the control handle according to the second embodiment of the present disclosure.

The main difference between the present embodiment and the previous embodiment is that the two connectors of the connector assembly 3 in the present embodiment are independent components. In addition, these two connectors are independently operable to move relative to the handle portion 1 and between a connection position and a storage position. When each connector is located at the connection position, the connector protrudes from the inner side of the handle portion 1. When the connector is located at the storage position, the connector is hidden in the interior of the handle portion 1.

In the present embodiment, the two connectors are respectively defined as the first connector 31 and the second connector 32. The first connector 31 has a main body 311, and the second connector 32 has a main body 321. An operation portion 3111 and a connection portion 3112 are respectively disposed on two sides of the main body 311, and an operation portion 3211 and a connection portion 3212 are respectively disposed on two sides of the main body 321. Each of the operation portions 3111, 3211 is exposed from an outer side of the handle portion 1, and each of the connection portions 3112, 3212 is connected to a guide structure 14 that is disposed in the interior of the handle portion 1.

In practice, each of the connection portions 3112, 3212 includes two guide pillars. The two guide pillars of the connection portion 3112 are respectively a first positioning pillar 3112A and a second positioning pillar 3112B, and the two guide pillars of the connection portion 3212 are respectively a first positioning pillar 3212A and a second positioning pillar 3212B. The guide structure 14 of the handle portion 1 includes two guide grooves, which are respectively defined as a first guide groove 141 and a second guide groove 142.

Each of the first positioning pillars 3112A, 3212A is pivotally connected to the neighboring first guide groove 141, and each of the second positioning pillars 3112B, 3212B is pivotally connected to the neighboring second guide groove 142. When the operation portions 3111, 3211 are operated to move relative to the handle portion 1, the first positioning pillars 3112A, 3212A move along the first guide groove 141, and the second positioning pillars 3112B, 3212B move along the second guide groove 142.

Each end of the first guide groove 141 and each end of the second guide groove 142 are in spatial communication with each other. The first guide groove 141 is disposed adjacent to the inner side of the handle portion 1, and the second guide groove 142 is disposed away from the inner side of the handle portion 1. When the first connector 31 is located at the storage positon, the first positioning pillar 3112A and the second positioning pillar 3112B of the first connector 31 are substantially located on a same axis.

During a process in which the operation portion 3211 of the second connector 32 is operated to move in a direction toward the first connector 31, the first positioning pillar 3212A and the second positioning pillar 3212B of the second connector 32 will correspondingly move along the first guide groove 141 and the second guide groove 142, and the second connector 32 will gradually rotate until the rotation reaches 90 degrees. In this way, the second connector 32 changes from the storage position to the connection position.

In practice, the handle portion 1 and each connector can also be configured to include a handle positioning structure and a main body positioning structure that are similar to those mentioned in the previous embodiment, so that the connector is less likely to rotate when being located at the connection position. For example, each connector can have a bump structure, and an upper housing of the handle portion 1 can correspondingly have a groove. When the connector is located at the connection position, the bump structure will be engaged with the groove, thereby limiting a movement range of the connector.

Based on the above, through the configuration of a first guide groove, a second guide groove, a first positioning pillar, and a second positioning pillar, the user can easily operate the handle portion of each connector for enabling the connector to change between the connection position and the storage position.

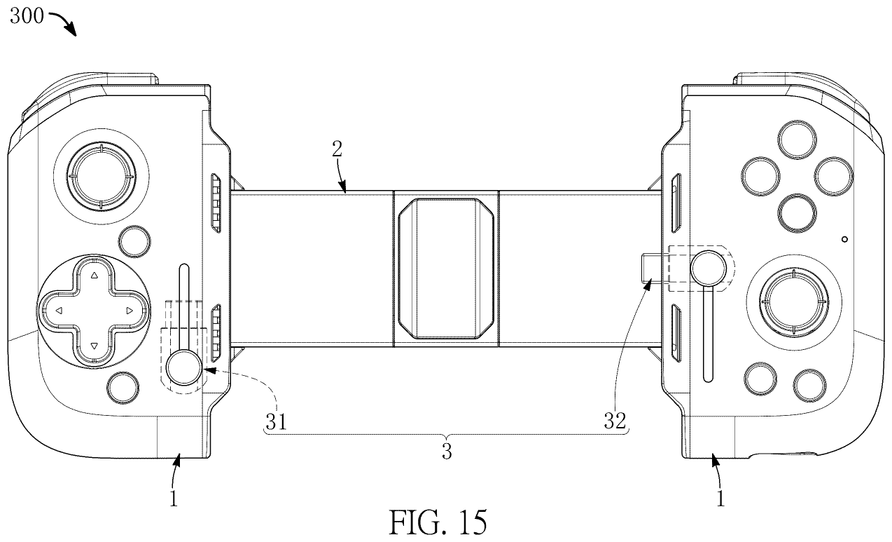

Reference is made to FIG. 15, which is a schematic view of a control handle according to a third embodiment of the present disclosure. The control handle 100 of the present embodiment includes the two connectors of different types, which are respectively the first connector 31 and the second connector 32. The first connector 31 is disposed in one of the handle portions 1, and the second connector 32 is disposed in another one of the handle portions 1.

The connectors and the handle portion 1 in which each connector is disposed include the operation portions 3111, 3211, the connection portions 3112, 3212, and the guide structure 14 mentioned in the previous embodiments. The user can operate the operation portions 3111, 3211 of the connector according to practical requirements, so that the connector changes between the connection position and the storage position.

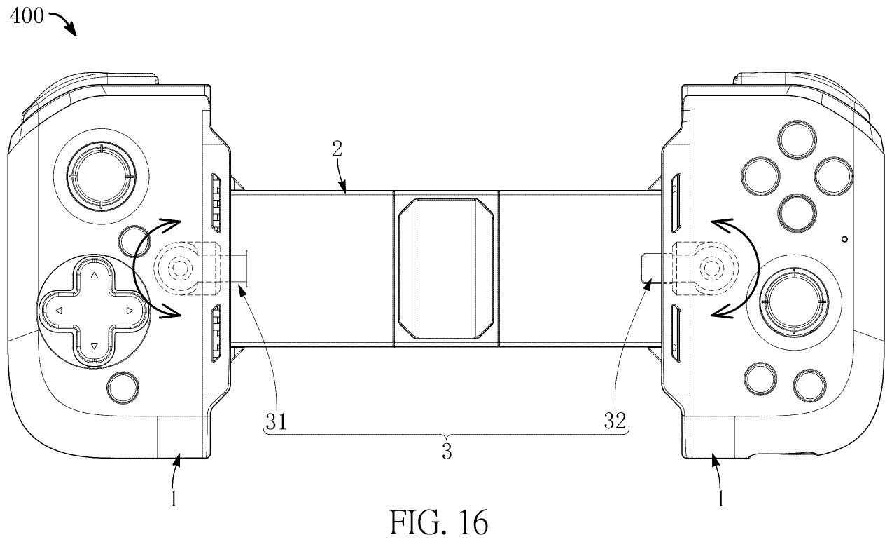

Reference is made to FIG. 16, which is a schematic view of a control handle according to a fourth embodiment of the present disclosure. The control handle 100 of the present embodiment includes the two connectors of different types, which are respectively the first connector 31 and the second connector 32. The first connector 31 is disposed in one of the handle portions 1, and the second connector 32 is disposed in another one of the handle portions 1. Each connector is rotatable relative to the handle portion 1, so as to protrude from the inner side of the handle portion 1 or be hidden in the interior of the handle portion 1.

### Beneficial Effects of the Embodiments

In conclusion, in the control handle and the connector assembly provided by the present disclosure, the user can operate the connector of the control handle for enabling the control handle to be connected with electronic devices of different types.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connector assembly of a control handle, the connector assembly being movably disposed in the control handle, the control handle including two handle portions and a support portion, a plurality of operation components being disposed on each of the two handle portions, each of the plurality of operation components being configured to be operable by a user for correspondingly generating a control signal, two ends of the support portion being connected to the two handle portions, the control handle being configured to hold an electronic device, and the connector assembly comprising:
at least two connectors of different types, wherein each of the at least two connectors is movably disposed in one of the handle portions, each of the at least two connectors is operable to protrude from an inner side of the handle portion, and the connector that protrudes from the inner side of the handle portion is configured to be mated with a mating connector of the electronic device that is held by the control handle.

2. The connector assembly according to claim 1, wherein the at least two connectors are disposed in a main body of the connector assembly, the main body is disposed in one of the handle portions, and the at least two connectors are electrically connected to a circuit module that is disposed in the handle portion via an electrical wire.

3. The connector assembly according to claim 2, wherein the inner side of the handle portion on which the at least two connectors are disposed has an opening, the main body is rotatably disposed in the handle portion, and the at least two connectors are operable to rotate relative to the handle portion, so as to enable one of the at least two connectors to protrude from the inner side of the handle portion.

4. The connector assembly according to claim 3, wherein the at least two connectors are respectively defined as a first connector and a second connector, the main body includes at least one main body positioning structure, and the handle portion includes at least two handle positioning structures; wherein, when the at least one main body positioning structure is engaged with one of the at least two handle positioning structures, the first connector protrudes from the inner side of the handle portion, and the second connector is hidden in the handle portion; and wherein, when the at least one main body positioning structure is engaged with another one of the at least two handle positioning structures, the second connector protrudes from the inner side of the handle portion, and the first connector is hidden in the handle portion.

5. A control handle, comprising:
two handle portions, wherein a plurality of operation components are disposed on each of the two handle portions, and each of the plurality of operation components is configured to be operable by a user for correspondingly generating a control signal;
a support portion, wherein two ends of the support portion are connected to the two handle portions, and the control handle is configured to hold an electronic device; and
a connector assembly, wherein the connector assembly includes:
at least two connectors of different types, wherein each of the at least two connectors is movably disposed in one of the handle portions, each of the at least two connectors is operable to protrude from an inner side of the handle portion, and the connector that protrudes from the inner side of the handle portion is configured to be mated with a mating connector of the electronic device that is held by the control handle.

6. The control handle according to claim 5, wherein the at least two connectors are disposed in a main body of the connector assembly, the main body is disposed in one of the handle portions, and the at least two connectors are electrically connected to a circuit module that is disposed in the handle portion via an electrical wire.

7. The control handle according to claim 6, wherein the inner side of the handle portion on which the at least two connectors are disposed has an opening, the main body is rotatably disposed in the handle portion, and the at least two connectors are operable to rotate relative to the main body, so as to enable one of the at least two connectors to protrude from the inner side of the handle portion.

8. The control handle according to claim 7, wherein the at least two connectors are respectively defined as a first connector and a second connector, the main body includes at least one main body positioning structure, and the handle portion includes at least two handle positioning structures; wherein, when the at least one main body positioning structure is engaged with one of the at least two handle positioning structures, the first connector protrudes from the inner side of the handle portion, and the second connector is hidden in the handle portion; and wherein, when the at least one main body positioning structure is engaged with another one of the at least two handle positioning structures, the second connector protrudes from the inner side of the handle portion, and the first connector is hidden in the handle portion.

9. The control handle according to claim 5, wherein the control handle further includes a protection structure, the protection structure includes a holding portion and a shielding portion, the holding portion is configured to clamp the support portion, and the shielding portion is configured to shield at least a portion of an opening of the handle portion in which the at least two connectors are disposed, so as to restrict the at least two connectors from being operated to move relative to the handle portion.

10. The control handle according to claim 5, wherein each of the at least two connectors is movably disposed in the handle portion, and each of the at least two connectors is independently operable to move relative to the handle portion, so as to be hidden in an interior of the handle portion or protrude from the handle portion.

11. The control handle according to claim 10, wherein each of the at least two connectors has a main body, an operation portion and a connection portion are respectively disposed on two sides of the main body, the operation portion is exposed from an outer side of the handle portion, and the connection portion is connected to a guide structure that is disposed in the interior of the handle portion; wherein each of the operation portions is operable to enable the connection portion of the main body to move relative to the handle portion along a corresponding one of the guide structures, so that each of the at least two connectors changes between a connection position and a storage position; and wherein each of the at least two connectors protrudes from the handle portion when being located at the connection position, and is hidden in the interior of the handle portion when being located at the storage position.

12. The control handle according to claim 11, wherein, when one of the at least two connectors is located at the storage position, the operation portion of another one of the at least two connectors is operable to move in a direction close to or away from the one of the at least two connectors; and wherein, when the at least two connectors are both located at the storage position, the operation portion of any one of the at least two connectors is operable to move in a direction toward another one of the at least two connectors and then rotate, so as to move to the connection position.

13. A control handle, comprising:
two handle portions, wherein a plurality of operation components are disposed on each of the two handle portions, and each of the plurality of operation components is configured to be operable by a user for correspondingly generating a control signal;
a support portion, wherein two ends of the support portion are connected to the two handle portions, and the control handle is configured to hold an electronic device; and
a connector assembly, wherein the connector assembly includes:
at least two connectors of different types, wherein the at least two connectors are movably disposed in the two handle portions, each of the at least two connectors is operable to protrude from an inner side of a corresponding one of the handle portions, and the connector that protrudes from the inner side of the handle portion is configured to be mated with a mating connector of the electronic device that is held by the control handle.

14. The control handle according to claim 13, wherein each of the at least two connectors is operable to rotate relative to the corresponding one of the handle portions, so that each of the at least two connectors is hidden in or protrudes from the corresponding one of the handle portions.

15. The control handle according to claim 13, wherein each of the at least two connectors is fixed to a main body, an operation portion and a connection portion are respectively disposed on two sides of the main body, the operation portion is exposed from an outer side of the handle portion, and the connection portion is connected to a guide structure that is disposed in an interior of the handle portion; wherein each of the operation portions is operable to enable the connection portion of the main body to move relative to the handle portion along a corresponding one of the guide structures, so that each of the at least two connectors changes between a connection position and a storage position; and wherein each of the at least two connectors protrudes from the handle portion when being located at the connection position, and is hidden in the interior of the handle portion when being located at the storage position.

16. The control handle according to claim 13, wherein the control handle further includes two protection structures, each of the two protection structures includes a holding portion and a shielding portion, the holding portion is configured to clamp the support portion, and the shielding portion is configured to shield at least a portion of an opening of the handle portion, so as to restrict the at least two connectors from being operated to rotate relative to the handle portions.

17. The control handle according to claim 13, wherein the control handle further includes a protection structure, the protection structure includes a holding portion and a shielding portion, the holding portion is configured to clamp the support portion, and the shielding portion is configured to shield at least a portion of an opening of one of the two handle portions in which one or more of the at least two connectors is disposed, so as to restrict the one or more of the at least two connectors from being operated to move relative to the handle portion.
